(19) United States
(12) Patent Application Publication
(10) Pub. No.: US 2019/0370789 A1
(43) Pub. Date: Dec. 5, 2019

(54) DISTRIBUTED BLOCK CHAIN CRYPTOCURRENCY SYSTEM FOR SECUREMENT AGAINST UNAUTHORISED TRANSACTIONS

(71) Applicant: NEW TRUST IP LIMITED, Auckland, (NZ)

(72) Inventor: Scott McCALLUM, Coolamon (AU)

(73) Assignee: Intermine.com.au Pty Ltd, Coolamon (AU)

(21) Appl. No.: 16/484,759

(22) PCT Filed: Feb. 12, 2018
(86) PCT No.: PCT/AU2018/050108

§ 371 Date: Aug. 8, 2019

(30) Foreign Application Priority Data
Feb. 10, 2017 (AU) 2017900420
Dec. 8, 2017 (AU) 2017904948

(51) Int. Cl. G06Q 20/36; H04L 9/06; G06Q 20/22; G06Q 20/06; G06Q 20/38

(52) U.S. Cl. CPC G06Q 20/3672; H04L 9/0637; G06Q 20/3827; G06Q 20/0658; G06Q 20/223

(57) ABSTRACT

There is provided herein a disrupted block chain cryptocurrency system for securement against unauthorised transactions from the theft of private keys wherein the mining computing devices thereof comprise transaction pre-processors which, for each cryptocurrency transaction received, identifies an address associated with the cryptocurrency transaction and searches the block chain ledger for at least one previous cryptocurrency transaction of a specific format associated with the address. If such a transaction is found, the transaction is held in a memory pool for security as opposed to adding to a block for hashing and a further address is identified from the at least one previous transaction. The transaction is held in the memory pool until a further cryptocurrency transaction from the further address is pre-processed which comprises meta data identifying a transaction ID of the transaction stored within the memory pool for removal and adding to a block for hashing.

### FIELD OF THE INVENTION

This invention relates generally to block chain systems and, more particularly, to a method and system for securing block chain cryptocurrency transactions against unauthorised cryptocurrency transactions from private key theft and misuse.

### BACKGROUND OF THE INVENTION

Block chain cryptocurrency systems comprise a peer-to-peer network of computers allowing the transference of cryptocurrency between addresses. A user may create a private key from which a public key may be derived. An address may be further derived from the public key.

The most common way to transfer currency is to create a transaction which is signed with the private key. The transaction may be subsequently verified utilising the published public key.

Such systems comprise miners across a peer-to-peer network which add cryptocurrency transactions to blocks of a distributed block chain ledger in a proof-of-work process. Specifically, miners compete to identify a block hash of a certain specificity indicated by the number of leading zeros of the hash. The number of leading zeros are adjusted over time to control the mining rate.

The miner finding a matching hash is rewarded with newly mined cryptocurrency by way of a “coinbase” transaction and the associated transaction fees.

Today, users typically avail themselves of online service providers to provide hosted wallet software which manages the user's wallet public and private keys and associated addresses. Other users may implement personal computer-controlled wallets.

However, present systems are problematic in that such hosted services and personal computing devices are often hacked and the private keys stolen which are then used to create untraceable unauthorised cryptocurrency transactions.

Current methods for securing against unauthorised cryptocurrency transactions comprise multi signature addresses, off-line “cold storage” addresses and the like which have associated disadvantages.

Furthermore, present systems are problematic in that loss of the private keys may result in unspent cryptocurrency being unspendable.

The present invention seeks to provide a way will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE DISCLOSURE

There is provided herein a distributed block chain cryptocurrency system which is securable against unauthorised transactions caused by theft of private keys.

The present system comprises mining computing devices characterised in comprising a transaction preprocessor which either allows an associated mining controller to add received transactions to a block for proof-of-work hashing or alternatively holds the transaction in abeyance a memory pool for security.

Specifically, for each received transaction, the transaction preprocessor identifies an address associated with the received transaction and searches for previous transactions of a specific format within the block chain ledger using the address (typically using a search index).

In embodiments, these previous transactions of a specific format comprise transactions comprising a first output (such as a null datatype output) which includes a recognisable metadata pattern and a second output (a Pay-to-PubkeyHash output) transferring a null or nominal value to the identified address. In embodiments, the present system may be limited to process only the null datatype and Pay-to-PubkeyHash type outputs.

In embodiments, the metadata is encoded within the OP_RETURN field of the public key script of the transaction. Use of the OP_RETURN advantageously automatically fails the spendable script test thereby avoiding cluttering the unspent output list (UXTO) held in memory.

These previous transactions are indelibly stored within the ledger so as to allow for the subsequent preprocessing by the transaction preprocessor in the manner described herein.

For example, the previous transactions may be used to create a relationship within the blockchain between a more secure first address and a second address.

As such, in accordance with one embodiment, should the transaction preprocessor identify such an address relationship from these previous transactions within the blockchain, the transaction preprocessor holds any further transactions transferring cryptocurrency from the second address (i.e. transactions having an input having a transaction ID associated with a previous transaction having an output specifying the second address) in abeyance in a memory pool for security such that these further transactions are not immediately added to blocks for hashing.

The addition of the transaction to the memory pool may be transmitted to the other miner peers across the network.

The system is further configured for the subsequent retrieval of the transactions from the memory pool for use wherein the transaction preprocessor may further preprocess further received transactions and identify a further transaction as being of a specific authorisation-type format by inspecting the metadata encoded therein in the null datatype output.

For example, the further transaction may encode a metadata pattern specifying the transaction ID of the transaction within the memory pool within the OP_RETURN field of the public key script of a null datatype output. In embodiments, an index of the transaction ID may be used such as a shortened hash, checksum or the like to reduce the metadata to fit within the applicable byte limit which, for example, may be 40 bytes for the Bitcoin network.

When identifying the transaction ID from the further received transaction, the transaction preprocessor is configured for searching and retrieving the transaction from the memory pool using the transaction id for sending to the mining controller for adding to a block in the conventional manner.

As such, with such a configuration, having generated these transaction of a specific format which are then stored in the blockchain, if the private key associated with the second address is stolen, the unspent cryptocurrency associated with the second address cannot be spent, until such time that a further transaction is generated that is signed by a private key associated with the related first address.

In accordance with a further embodiment, the present system addresses problems of lost private keys which would otherwise result in the inability to spend unspent cryptocurrency from the associated address.

In accordance with this embodiment, a further cryptocurrency transaction of a further specific format may be stored within the block chain which is identified by the transaction preprocessor to effectively lock an affected address. Specifically, if identifying such a further cryptocurrency transaction of the further specific format, the transaction preprocessor may delete any subsequent transactions seeking to transfer cryptocurrency from the affected account (i.e. having a transaction ID associated with a previous transaction having an output specifying the affected account).

Furthermore, in embodiments, when first identifying the further cryptocurrency transaction of the further specific format, the transaction preprocessor may add an additional output to the coin base transaction of a block to create and transfer replacement cryptocurrency to a specific address.

As such, with the foregoing in mind, in accordance with one aspect, there is provided a distributed block chain cryptocurrency system for securement against unauthorised transactions, the system comprising: at least one client computing device in operable communication with a peer-to-peer network of cryptocurrency mining computing devices across a data network, each mining computing device comprising a processor and a memory device operably coupled thereto, the memory device having computer program code controller instructions therein executable by the processor and comprising data including a transaction memory pool, wherein each mining computing device comprises a mining controller executable by the processor for receiving cryptocurrency transactions from the at least one client computing device across the network, conducting proof-of-work hashing calculations on the cryptocurrency transactions and adding the cryptocurrency transactions to a distributed block chain ledger of the network wherein: each mining computing device further comprises a transaction preprocessor controller configured for, for each cryptocurrency transaction of the cryptocurrency transactions: identifying an address associated with an input of the cryptocurrency transaction; searching the blockchain ledger using the address for at least one previous cryptocurrency transaction of a specific format within the blockchain ledger; if the at least one previous cryptocurrency transaction is not found, sending the cryptocurrency transaction to the mining controller for adding to a block for the proof-of-work hashing; and if the at least one previous cryptocurrency transaction is found: identifying a further address from the at least one previous cryptocurrency transaction; adding the cryptocurrency transaction to the transaction memory pool; receiving a further cryptocurrency transaction of a further specific format; and if identifying that the further cryptocurrency transaction is from the further address: identifying a transaction id of the first cryptocurrency transaction from the further cryptocurrency transaction; searching and retrieving the first cryptocurrency transaction from the memory pool using the transaction id; and sending the first cryptocurrency transaction to the mining controller for adding to a block for the proof-of-work hashing.

As such, the system may prevent unauthorised spending of unspent cryptocurrency associated with the second address in the event of the loss of the private keys associated with the second address.

The at least one previous cryptocurrency transaction may comprise two cryptocurrency transactions having a cryptocurrency transaction having an output specifying the further address and a further cryptocurrency transaction having an output specifying the address.

The further cryptocurrency transaction has a blocktime later than that of the cryptocurrency transaction.

The transaction preprocessor may be configured for identifying the at least one previous cryptocurrency transaction by inspecting metadata associated with the at least one previous cryptocurrency transactions.

The transaction preprocessor may be configured for identifying metadata of a specific metadata pattern.

The at least one previous cryptocurrency transaction may comprise a pair of outputs comprising: a first output comprising the specific metadata pattern; and a second output.

The first data output may be a nulldata type output and wherein the metadata may be encoded within a public key script of the first output.

The metadata may be encoded as an OP_RETURN value.

The second output may be a Pay-to-PubkeyHash transaction.

The further received cryptocurrency transaction may comprise a metadata pattern and wherein the transaction preprocessor controller may be configured for identifying the transaction ID from within the metadata pattern.

The metadata pattern may comprise an index of the transaction ID.

The index may comprise at least one of a hash, checksum and truncation of the transaction ID.

The metadata pattern may be less than 40 bytes.

The system may be further configured for transmitting data indicative of the adding of the cryptocurrency transaction to the transaction memory pool to other mining computing devices across the data network.

The system may be further configured for expunging the cryptocurrency transaction from the memory pool and sending data indicative of the expungement to other mining computing devices across a data network.

The transaction preprocessor may be further configured for: searching the blockchain ledger for at least one previous cryptocurrency transaction of a further specific format; and if the at least one previous cryptocurrency transaction of the further specific format may be found: deleting the cryptocurrency transaction and/or adding an additional output to a coinbase transaction of the block.

As such, the system may be configured for addressing situations where private keys are lost which would otherwise have resulted in the unspent cryptocurrency associated therewith being unspendable.

The additional output may comprise a value derived from a value of unspent cryptocurrency associated with the address.

The output may specify the further address.

Identifying the address associated with the input of the cryptocurrency transaction may comprise retrieving transaction data of a previous cryptocurrency transaction using a transaction ID of an input of the cryptocurrency transaction and identifying the address from an output of the previous cryptocurrency transaction.

Identifying that the further cryptocurrency transaction may be from the further address may comprise retrieving transaction data of a previous cryptocurrency transaction using a transaction ID of an input of the further cryptocurrency transactions and identifying the further address has an output of the previous cryptocurrency transaction.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a distributed block chain cryptocurrency system for securement against unauthorised transactions in accordance with an embodiment;

FIG. 2 shows an exemplary cryptocurrency transaction in accordance with an embodiment; and

FIG. 3 shows exemplary processing by the system of FIG. 1 in accordance with an embodiment.

### DESCRIPTION OF EMBODIMENTS

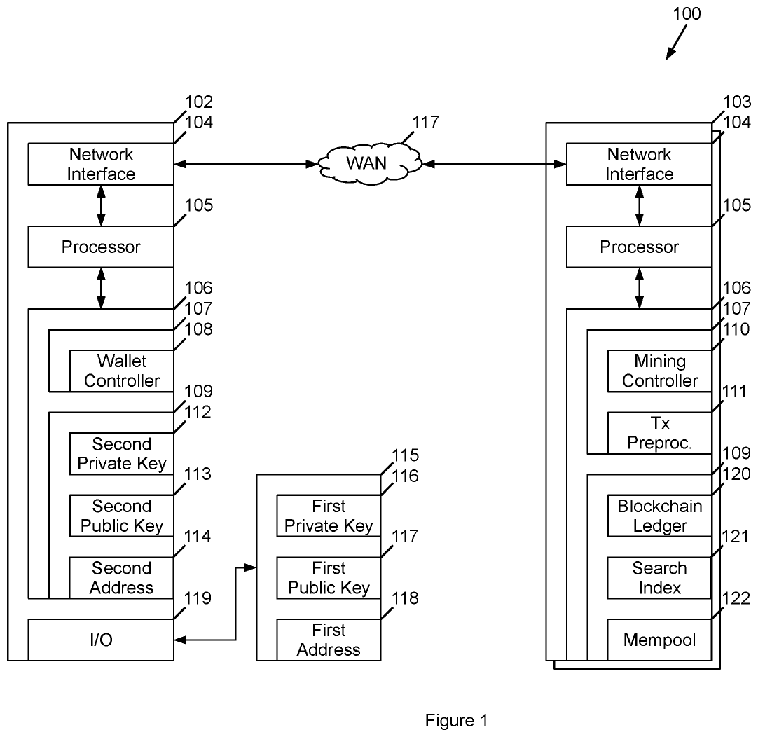

FIG. 1 illustrates a distributed block chain cryptocurrency system 100 for securement against unauthorised transactions in accordance with an embodiment.

The system 100 comprises at least one client computing device 102 which may take the form of a personal computing device, online cryptocurrency service provider server or the like. The at least one client computing device 102 is in operable communication with a peer-to-peer network of cryptocurrency mining computing devices 103 across a data network 117. Mining computing devices 103 may take the form of computing devices or servers and associated software or bespoke hardware devices and associated firmware.

Each computing device 102, 103 comprises a processor 105 for processing digital data. Furthermore, each computing device 102, 103 comprises a memory device 106 operably coupled to the processor 105. The memory device 106 comprises computer program code controller instructions 107 therein executable by the processor 106 in accordance with associated data 109.

Each mining computing device 103 comprises a mining controller 110 executable by the processor 105 to receive cryptocurrency transactions from the at least one client computing device 102 across the network 117.

The mining controller 110 adds received transactions to a block and performs proof-of-work hashing compilations thereon wherein, if a hash result of a certain degree of specificity is discovered, such is announced to the peers 103 of the network and the associated block is added to the block chain ledger 120 of which each mining computer device 103 may store a copy.

In accordance with present embodiments however, each mining computing device 103 further comprises a transaction preprocessor controller 110. For each cryptocurrency transaction received by the mining computing device 103, and prior to adding to a block for hashing, the transaction preprocessor 110 is configured for performing preprocessing thereon in the manner described herein the result of which either results in the transaction being added to the block for hashing or being held in abeyance.

More specifically, for each received transaction, transaction preprocessor 111 is configured for searching the block chain ledger 120, or preferably a search index 121 thereof, to identify at least one previous cryptocurrency transaction of a specific format specifying an address associated with the transaction.

If the at least one cryptocurrency transaction of the specific format is not found, the transaction preprocessor 111 passes the cryptocurrency transaction to the mining controller 110 to add to a block for hashing.

However, if the at least one cryptocurrency transaction of the specific format is found, the transaction preprocessor 111 holds the cryptocurrency transaction in abeyance, such as by adding the cryptocurrency transaction to a memory pool 122.

The memory pool 122 may be replicated to the other peers 103 of the network.

The cryptocurrency transaction is held in abeyance in the memory pool 122 by the transaction preprocessor 111 until such time that the transaction preprocessor 111 receives a further cryptocurrency transaction of a further specific format and is able to identify a transaction ID of the transaction held in abeyance in the memory pool 122 from the further cryptocurrency transaction. The transaction preprocessor 111 then searches the memory pool 122 using the transaction ID and receives the transaction therefrom.

The transaction is then passed to the mining controller 110 for adding to a block for hashing.

The transaction may then be expunged from the memory pool 122 and the expungement thereof replicated to the other peers 103 across the network.

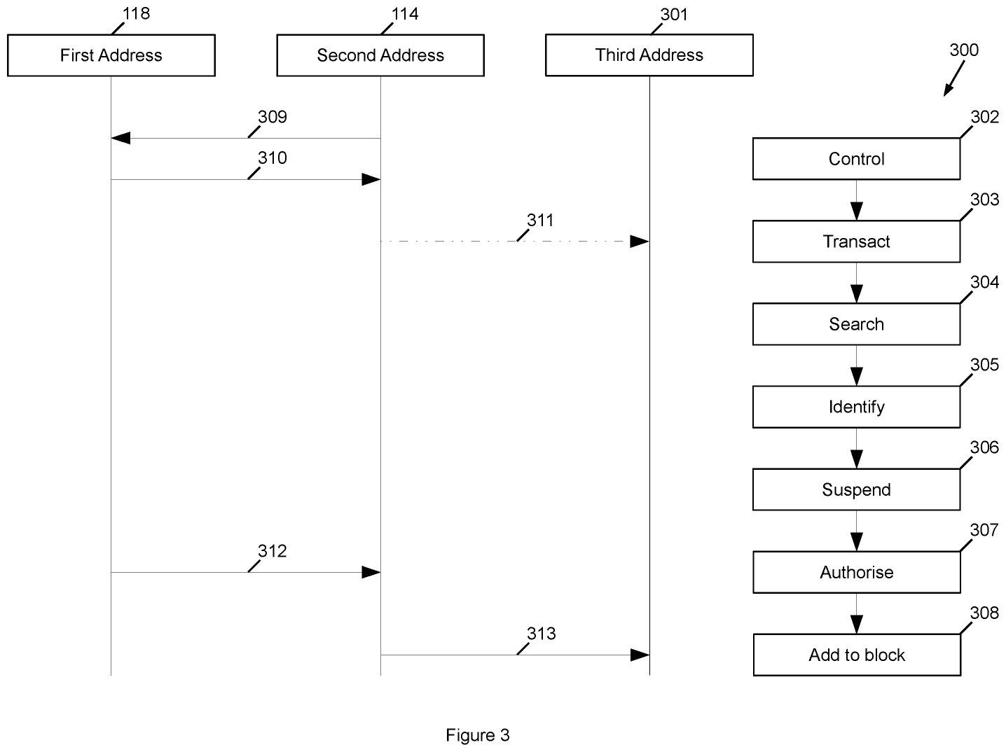

Exemplary processing 300 of the system 100 will now be described with reference to FIG. 3.

With reference to FIG. 1, there is shown the data 109 of the memory device 106 comprising a private key 112, referred to herein as a second private key from which a public key 113, referred to herein as a second public key, may be derived. An address 114, referred to herein as a second address 114 may be derived from the second public key 113.

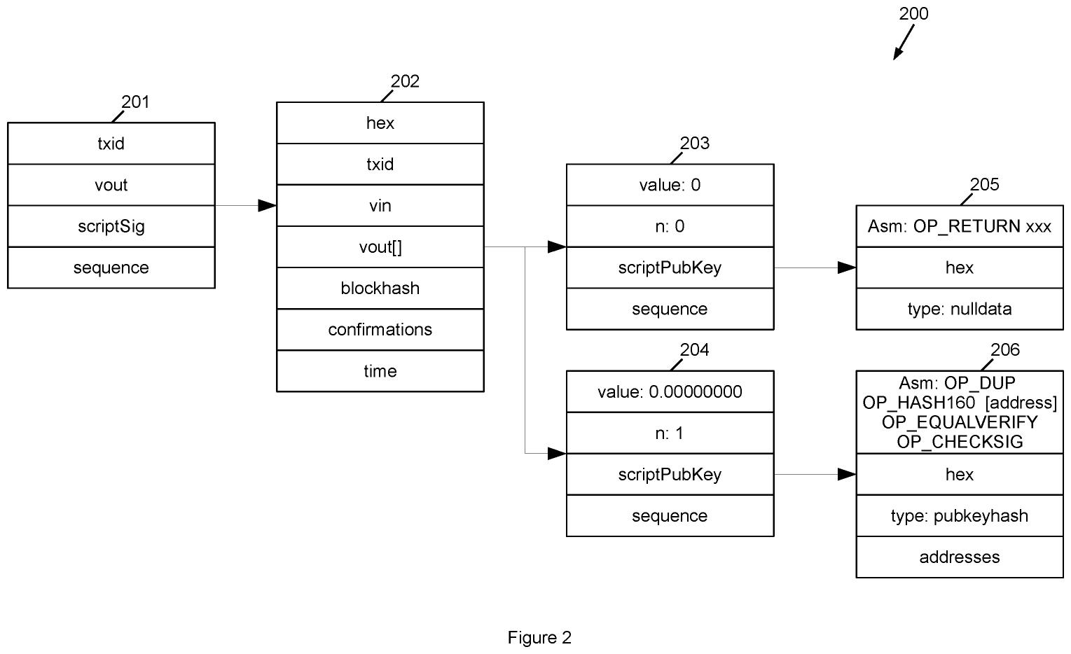

The private key 112 may be a randomly generated 256 bit private key. The private key 112 is used to sign a transaction 202 (as is provided in FIG. 2) to spend cryptocurrency. The private key 112 must be kept secret. The public key 113 is generated from the private key 112. In embodiments, and elliptic curve DSA algorithm generates a 512 bit (or 257 bit compressed) public key 113 from the private key 112. The public key 113 is used to verify the signature on a transaction.

The address 114 may be generated from the public key 113 and shared with other users for implementing cryptocurrency transactions.

In embodiments, the 512 bit public key 113 is hashed down to 160 bits utilising the SHA-256 and RIPEMD hash algorithms and ASCII encoded. The resulting address 114, such as 1KKHA6N21XKKt0sWKuQKXdvSsCf95ibHFa, is the address users publish in order to receive currency.

A Wallet Interchange Format key (WIF) (which may be an ASCII encoded Base58Check encoding of the private key 109) may be used to add the private key 114 to a wallet controller 108 for use.

There is also shown a first set of a private key 116, public key 117 and address 118. This first set may be held more securely such as within cold storage 115 which, may for example, be printed matter or off-network memory device which may be read by an I/O interface 119 (such as a barcode scanner or USB port) of the client computing device 102 when required.

With reference to FIG. 3, the processing 300 comprises establishing an indelible control relationship between the first address 118 and the second address 114 at step 302 wherein transactions of the specific format are generated, either manually, or autonomously by the client competing device 102 which are stored within the block chain 120.

In one embodiment, a first transaction 309 is generated to transfer a nominal or null value of cryptocurrency from the second address 114 to the first address 118. Thereafter a second cryptocurrency transaction 310 may be generated to transfer a nominal or null value of cryptocurrency (which may be the same value of the first transaction 309) from the first address 118 to the second address 114. Variations of the number and direction of these control establishing-type transactions are envisaged within alternative embodiments.

These transactions 309, 310 are indelibly stored within the block chain ledger 120 by the mining computing devices 103.

The cold storage 115 may then be taken off-line.

The transaction 309, 310 are of a specific format so as to be identifiable by the transaction preprocessors 111 subsequently in the manner described herein.

FIG. 2 illustrates the anatomy of this specific format of transaction 202 in accordance with an embodiment which may be represented alternatively by the following exemplary structured notation:

{
“hex” : “010000...”,
“txid” : “8bae12b5f4c088d940733dcd1455efc6a3a69cf9340e17a981286d3778615684”,
“version” : 1,
“locktime” : 0,
“vin” : [

{

“txid” : “8e40bb1db9029dd648432c56c295788221c1dd97fe1dbee52f767d605fba58c8”,
“vout” : 1,
“scriptSig” : {

“asm” : “3045022044...”,
“hex” : “483045022...”

},
“sequence” : 4294967295

}

],
“vout” : [

{

“value” : 0.00000000,
“n” : 0,
“scriptPubKey” : {

“asm” : “OP_RETURN 40434F4D4D414E4440”,
“hex” : “6a13636861726c6579206c6f766573206865696469”,
“type” : “nulldata”

}

},
{

“value” : 0.00200000,
“n” : 1,
“scriptPubKey” : {

“asm” : “OP_DUP OP_HASH160 b8268ce4d481413c4e848ff353cd16104291c45b OP_EQUALVERIFY

OP_CHECKSIG”,

“hex” : “76a914b8268ce4d481413c4e848ff353cd16104291c45b88ac”,
“reqSigs” : 1,
“type” : “pubkeyhash”,
“addresses” : [

“1HnhWpkMHMjgt167kvgcPyurMmsCQ2WPgg”

]

}

}

],
“blockhash” : “000000000000000004c31376d7619bf0f0d65af6fb028d3b4a410ea39d22554c”,
“confirmations” : 2655,
“time” : 1404107109,
“blocktime” : 1404107109
}

In the above example, certain data has been truncated where represented by ellipsis.

In a preferred embodiment, the transaction 202 encodes metadata. In a specific embodiment, the transaction 202 employs nulldata type outputs encoding the metadata as an OP_RETURN value within the asm field of the public key script.

Specifically, referencing FIG. 2, there is shown the transaction 202 comprising an input 201, having a transaction ID of a previous transaction. Now, for each of the transactions 309, 310, the transaction 202 may comprise two outputs 203, 204 which, in an embodiment, may comprise a nulldata type output (shown as output vector index 0) and a Pay-to-PubkeyHash output (shown as output vector index 1).

The nulldata type transaction may encode metadata according to the following metadata patterns 401-407:

| | | | UTF-8 |
|---|---|---|---|
| | Metadata pattern | HEX encoding | bytes |
| 401 | @COMMAND@ | 40434F4D4D414E4440 | 18 |
| 402 | @COMMAND1@ | 40434F4D4D414E443140 | 20 |
| 403 | @COMMAND2@ | 40434F4D4D414E443240 | 20 |
| 404 | @AUTH@8bae12b5f4c088d940733 | 404155544840386261653132623566346330 | 140 |
| | dcd1455efc6a3a69cf9340e17a9 | 383864393430373333646364313435356566 | |
| | 81286d3778615684 | 633661336136396366393334306531376139 | |
| | | 38313238366433373738363135363834 | |
| 405 | @AUTH@3DF810DC | 4041555448403344463831304443 | 28 |
| 406 | @CLOSE@ | 40434C4F534540 | 14 |
| 407 | @SAFETY@ | 4053414645545940 | 16 |

The output 203 may comprise a HEX encoding of the pattern which is also shown along with the UTF-8 byte length in the table above.

Differing cryptocurrency transactions may allow OP_RETURN value fields of differing lengths. For example, the OP_RETURN field value length of the bitcoin network is 40 bytes.

As such, the exemplary metadata pattern 404 given above which encodes a transaction ID may exceed such a restriction and, as such, the transaction may be shortened into an index using, for example, the Adler-32, Fletcher-32 or the like checksum algorithm such as is given in the metadata pattern example 405. In embodiments, the transaction ID may be truncated.

As such, the control 302 processing of FIG. 3 may comprise the generation of the transaction 309 comprising a null data type output encoding the metadata pattern @COMMAND@ and a Pay-to-PubkeyHash output transferring a null or nominal value to the first address 118.

The control processing 302 may further comprise generation of the further transaction 310 comprising a null data type output encoding the metadata pattern @COMMAND@ and a Pay-to-PubkeyHash output transferring a null or nominal value to the second address 114.

As alluded to above, once having initiated transactions 309, 310, the first set of keys 116, 117 may be taken off-line 115.

Referencing FIG. 3, the processing 300 further comprises the mining computing devices 103 receiving a first cryptocurrency transaction 311 from the client computing device 102 to transfer an amount from the second address 114.

In other words, the first cryptocurrency transaction 311 may comprise an input specifying a transaction ID (txid) representing a previous transaction having an output specifying the second address. As such, the first cryptocurrency transaction 311 is seeking to transfer unspent cryptocurrency from the previous transaction from the second address to another address.

However, as opposed to the mining controller 110 adding the cryptocurrency transaction 311 to the block for hashing in the conventional manner, the transaction preprocessor 111 firstly performs preprocessing, the result of which dictates whether the transaction 311 is added to the block or not.

As such, the processing 300 comprises the transaction preprocessor 111 searching the block chain ledger 120 but preferably a faster search index 121 thereof at step 300 to identify at least one previous cryptocurrency transaction of a specific format.

In accordance with the above provided embodiment, the transaction preprocessor 111 searches the search index 121 at step 304 to identify previous transactions within the ledger 120 having outputs comprising a 1) nulldata type transaction encoding the metadata pattern @COMMAND@ within the OP_RETURN field at step 305 and 2) a Pay-to-PubkeyHash output relating the second address to a first address.

The finding of no such transactions is indicative of the second address 114 being unsecured and therefore the transaction preprocessor 111 passes the transaction to the mining controller 110 for adding to the block in the conventional manner.

However, should the transaction preprocessor 110 identify the previous transactions 309, 310 having the recognisable metadata pattern, the transaction preprocessor 111 rather stores the transaction in the memory pool 122 in abeyance at step 306. The storing of the transaction within the memory pool 122 may be replicated to the other mining computing devices 103 across the network.

As such, the finding of the previous transactions 309, 310 is indicative of the securement of the second address 114 in the establishment of a relationship between the second address 114 and the first address 118. As such, for the secured second address 114, the transaction preprocessor 111 is configured for not processing any further transactions until such transactions are authorised from the more secure first address 118.

As such, should a user, or the client computing device 102 in an automated manner, have secured the second address 114 by generating transactions 309 and 310, no further transactions transferring value from the second address 114 will be processed by the network without authorisation.

As such, if the second private key 112 is stolen, transaction seeking to transfer value from the second address won't be processed by the system 100.

For the subsequent release and use of the transaction held in abeyance within the memory pool 122, the processing 300 comprises the receipt of a further transaction 312 at step 307 of a specific format.

For example, to authorise the transaction, the user may bring back online the more secure key set 116, 117 and generate the authorisation transaction 312.

Similarly, the authorisation transaction 312 may have a pair of outputs of the nulldata type and the, Pay-to-PubkeyHash type, the nulldata type transaction encoding the @AUTH@TX_ID data pattern as is given in exemplary metadata patterns 404 and 405 above.

As alluded to above, as the transaction ID may exceed the byte length limitation of the particular network, a shortened hash, checksum or the like may be utilised as is given above with reference to exemplary the metadata pattern 405.

The chances of collision using a hash, checksum or the like using are quite low despite the shortening of the transaction ID in this manner given that the number of transactions held in abeyance within the memory pool 122 is quite low compared to the number of transactions on the network. Furthermore, the transactions may be held in abeyance within the memory pool 122 for a relatively short time until such time that they are authorised for release.

As such, the transaction preprocessor 111 is configured for extracting the transaction ID or identifying such from the shortened hash, checksum thereof from the metadata pattern and searching the memory pool 122 for the corresponding transaction held in abeyance.

If successfully identifying the transaction within the memory pool 122, the transaction preprocessor 111 retrieves the transactions from the memory pool 122 and sends the transaction to the mining controller 110 for adding to a block for mining in the normal manner at step 308.

The transaction may be expunged from the memory pool 122 and such expungement may be communicated to the other mining computer devices 103 of the network.

In embodiments, and with reference to exemplary metadata patterns 402 and 403 above, plurality type metadata command patterns may be employed. For example, metadata pattern @COMMAND2@may indicate that two addresses are associated with the second address 114 and therefore that two authorising transactions 312 are required from both of the two associated address to authorise the transaction be removed from the memory pool 122.

In this manner, control initiating transaction 309, 310 may be initiated for each of the two addresses.

In embodiments, the second private keys 112 may be lost, resulting in the unspent cryptocurrency value associated with the second address 114 being unusable.

As such, in accordance with a further embodiment, a transaction may be generated from the first address having the close-type metadata pattern 406.

Similarly, the close type metadata pattern may comprise the nulldata type output encoding the metadata pattern and a further Pay-to-PubkeyHash output transferring a null or nominal value of cryptocurrency to the second address 114.

Such a close type transaction is again indelibly recorded within the block chain ledger 120.

As such, for any subsequent transactions transferring value from the closed second address 114, the transaction preprocessor 111 inspects the search index 121 for the close-type metadata pattern 406 wherein, if identified, the transaction is deleted. In other words, no transactions will be processed by the network transferring value from the closed second address 114 on account of the close type metadata pattern 406 residing within the ledger 120.

Additionally, when first identifying such a close type metadata pattern, the transaction preprocessor 111 may add transaction outputs to the first transaction (the “coin base” transaction) within the block to generate new cryptocurrency value to replace the value of the unspent cryptocurrency associated with the second address 114.

In one embodiment the coin base transaction has the first address 118 as an output such that the newly generated cryptocurrency may be associated with the first address 118.

Alternatively, the close type metadata pattern 406 may encode another specific address. For example, when generating the initiating transactions 309, 310, a further transaction having the meta data pattern 407 may be generated from the second address to a specific address. In such an embodiment, the coin base transaction has the specific address as the output of the coin base transaction.

In further embodiments, where plurality of addresses are associated with the second address 114 utilising a plurality of transactions 309, 310, the outputs of the coin base transaction may split the value amongst the plurality of associated addresses.

It should be noted that whereas the transaction preprocessor 111 has been described herein as inspecting meta data associated with previously cryptocurrency transactions within the ledger 120, in an alternative embodiment, the transaction preprocessor 111 may identify previous cryptocurrency transactions to one or more “well-known” addresses, each of which correspond to a corresponding function. For example, cryptocurrency transactions 309, 310 may be employed to establish a control-type relationship between the first and second addresses 118, 114 wherein cryptocurrency transactions may be subsequently issued from the first address 118 to each of the different types of well-known addresses such as those corresponding to lock, unlock, authorise and close well-known addresses. Identification of the most recent in time transaction from the first address 118 associated with the second address 114 will allow the preprocessor 111 to any subsequently received cryptocurrency transactions accordingly.

Whereas the embodiments herein have been described primarily with reference to cryptocurrency block chain systems, such may be applicable for other types of block chain systems also.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A distributed block chain cryptocurrency system for securement against unauthorised transactions, the system comprising:
at least one client computing device in operable communication with a peer-to-peer network of cryptocurrency mining computing devices across a data network, each mining computing device comprising a processor and a memory device operably coupled thereto, the memory device having computer program code controller instructions therein executable by the processor and comprising data including a transaction memory pool, wherein each mining computing device comprises a mining controller executable by the processor for receiving cryptocurrency transactions from the at least one client computing device across the network, conducting proof-of-work hashing calculations on the cryptocurrency transactions and adding the cryptocurrency transactions to a distributed block chain ledger of the network wherein:
each mining computing device further comprises a transaction preprocessor controller configured for, for each cryptocurrency transaction of the cryptocurrency transactions:
identifying an address associated with an input of the cryptocurrency transaction;
searching the blockchain ledger using the address for at least one previous cryptocurrency transaction of a specific format within the blockchain ledger;
if the at least one previous cryptocurrency transaction is not found, sending the cryptocurrency transaction to the mining controller for adding to a block for the proof-of-work hashing; and
if the at least one previous cryptocurrency transaction is found:
identifying a further address from the at least one previous cryptocurrency transaction;
adding the cryptocurrency transaction to the transaction memory pool;
receiving a further cryptocurrency transaction of a further specific format; and
if identifying that the further cryptocurrency transaction is from the further address:
identifying a transaction id of the first cryptocurrency transaction from the further cryptocurrency transaction;
searching and retrieving the first cryptocurrency transaction from the memory pool using the transaction id; and
sending the first cryptocurrency transaction to the mining controller for adding to a block for the proof-of-work hashing.

2. A system as claimed in claim 1, wherein the at least one previous cryptocurrency transaction comprises two cryptocurrency transactions having a cryptocurrency transaction having an output specifying the further address and a further cryptocurrency transaction having an output specifying the address.

3. A system as claimed in claim 2, wherein the further cryptocurrency transaction has a blocktime later than that of the cryptocurrency transaction.

4. A system as claimed in claim 1, wherein the transaction preprocessor is configured for identifying the at least one previous cryptocurrency transaction by inspecting metadata associated with the at least one previous cryptocurrency transactions.

5. A system as claimed in claim 4, wherein the transaction preprocessor is configured for identifying metadata of a specific metadata pattern.

6. A system as claimed in claim 5, wherein the at least one previous cryptocurrency transaction comprises a pair of outputs comprising:
a first output comprising the specific metadata pattern; and
a second output.

7. A system as claimed in claim 6, wherein the first data output is a nulldata type output and wherein the metadata is encoded within a public key script of the first output.

8. A system as claimed in claim 7, wherein the metadata is encoded as an OP_RETURN value.

9. A system as claimed in claim 6, wherein the second output is a Pay-to-PubkeyHash transaction.

10. A system as claimed in claim 1, wherein the further received cryptocurrency transaction comprises a metadata pattern and wherein the transaction preprocessor controller is configured for identifying the transaction ID from within the metadata pattern.

11. A system as claimed in claim 10, wherein the metadata pattern comprises an index of the transaction ID.

12. A system as claimed in claim 11, wherein the index comprises at least one of a hash, checksum and truncation of the transaction ID.

13. A system as claimed in claim 11, wherein the metadata pattern is less than 40 bytes.

14. A system as claimed in claim 1, further configured for transmitting data indicative of the adding of the cryptocurrency transaction to the transaction memory pool to other mining computing devices across the data network.

15. A system as claimed in claim 1, further configured for expunging the cryptocurrency transaction from the memory pool and sending data indicative of the expungement to other mining computing devices across a data network.

16. A system as claimed in claim 1, wherein the transaction preprocessor is further configured for:
searching the blockchain ledger for at least one previous cryptocurrency transaction of a further specific format; and
if the at least one previous cryptocurrency transaction of the further specific format is found:
deleting the cryptocurrency transaction.

17. A system as claimed in claim 1, wherein the transaction preprocessor is further configured for:
searching the blockchain ledger search index for at least one previous cryptocurrency transaction of a further specific format; and
if the at least one previous cryptocurrency transaction of the further specific format is found:
adding an additional output to a coinbase transaction of the block.

18. A system as claimed in claim 17, wherein the additional output comprises a value derived from a value of unspent cryptocurrency associated with the address.

19. A system as claimed in claim 18, wherein the output specifies the further address.

20. A system as claimed in claim 1, wherein identifying the address associated with the input of the cryptocurrency transaction comprises retrieving transaction data of a previous cryptocurrency transaction using a transaction ID of an input of the cryptocurrency transaction and identifying the address from an output of the previous cryptocurrency transaction.

21. A system as claimed in claim 1, wherein identifying that the further cryptocurrency transaction is from the further address comprises retrieving transaction data of a previous cryptocurrency transaction using a transaction ID of an input of the further cryptocurrency transactions and identifying the further address has an output of the previous cryptocurrency transaction.
